(19) United States
(12) Patent Application Publication
(10) Pub. No.: US 2025/0362019 A1
(43) Pub. Date: Nov. 27, 2025

(54) COMBUSTOR AND GAS TURBINE PROVIDED WITH SAME

(71) Applicant: MITSUBISHI HEAVY INDUSTRIES, LTD., Tokyo (JP)

(72) Inventors: Yoshikazu MATSUMURA, Yokohama-shi (JP); Keisuke Matsuyama, Tokyo (JP); Takanori Ito, Tokyo (JP); Tomohito Nakamori, Tokyo (JP); Koji Maeta, Tokyo (JP); Takaya Koda, Tokyo (JP); Atsushi Koyama, Yokohama-shi (JP)

(21) Appl. No.: 19/287,125

(22) Filed: Jul. 31, 2025

Related U.S. Application Data
(63) Continuation of application No. 17/941,537, filed on Sep. 9, 2022.
Application No. 17/941,537 is a continuation of application No. PCT/JP2021/011391, filed on Mar. 19, 2021.

(30) Foreign Application Priority Data
Mar. 23, 2020 (JP) 2020-050646

(51) Int. Cl. F23R 3/28; F02C 7/22

(52) U.S. Cl. CPC F23R 3/28; F02C 7/22

(57) ABSTRACT

This combustor is provided with an outer cylinder, an inner cylinder, a direct injection nozzle, a tail pipe, and a base end side acoustic attenuator. The outer cylinder is disposed inside a gas turbine casing. The inner cylinder is disposed on the inner circumferential side of the outer cylinder. The direct injection nozzle is disposed on the inner circumferential side of the inner cylinder. The tail pipe is connected to the inner cylinder, and fuel injected from the direct injection nozzle is burned on the inner circumferential side of the tail pipe. The base end side acoustic attenuator has an outer cylinder formation portion that is a part of a plate forming the outer cylinder, and an acoustic cover forming a base end side space in the gas turbine casing on the outer circumferential side of the outer cylinder in cooperation with the outer cylinder formation portion.

This application is a continuation of U.S. application Ser. No. 17/941,537, which is a continuation of PCT Patent Application No. PCT/JP2021/011391 filed on Mar. 19, 2021, which claims the benefit of priority of Japanese Patent Application No. 2020-050646 filed on Mar. 23, 2020. The entire contents of U.S. application Ser. No. 17/941,537, PCT Patent Application No. PCT/JP2021/011391 and Japanese Patent Application No. 2020-050646 are incorporated herein by reference.

### TECHNICAL FIELD

The present disclosure relates to a combustor having an acoustic damper and a gas turbine including the combustor.

### BACKGROUND ART

Gas turbines include a compressor that compresses air, a combustor that combusts fuel with the air compressed by the compressor to generate combustion gas, and a turbine that is driven by the combustion gas from the combustor.

Combustors generally have a transition piece (or combustion tube) through which fuel is combusted, a plurality of nozzles that inject fuel into the transition piece, an inner tube that covers the plurality of nozzles, and an acoustic damper that suppresses combustion vibration or the like. The transition piece and inner tube form a tubular shape around a combustor axis. Here, for the convenience of the following description, a direction in which the combustor axis extends is referred to as an axis direction, and one side of both sides in the axis direction is referred to as a tip side and the other side is referred to as a base end side. The transition piece is provided on the tip side of the inner tube. Additionally, the base end side of the inner tube is blocked with a base end plate or the like. Both the inner tube and the transition piece are disposed in a gas turbine casing. The acoustic damper has an acoustic cover that forms an acoustic space inside.

In a combustor described in the following PTL 1, the acoustic cover is disposed outside the gas turbine casing and attached to the base end plate. The base end plate is provided with acoustic holes penetrating into the gas turbine casing from the acoustic space.

### CITATION LIST

### Patent Literature

[PTL 1] Japanese Unexamined Patent Application Publication No. 2004-183944

### SUMMARY OF INVENTION

### Technical Problem

When the gas turbine is being driven, compressed air, which is the air compressed by the compressor, is present in the gas turbine casing in which the inner tube and the transition piece are disposed. For this reason, the pressure inside the gas turbine casing is higher than the atmospheric pressure. On the other hand, the pressure outside the gas turbine casing is the atmospheric pressure. In a technique described in PTL 1, since the acoustic space communicates with the gas turbine casing through the acoustic holes, the pressure in the acoustic space becomes the pressure in the gas turbine casing. That is, in the technique described in PTL 1, the pressure in the acoustic space becomes higher than the atmospheric pressure. In the technique described in the above PTL 1, since the acoustic cover forming the acoustic space is disposed outside the gas turbine casing, a pressure difference between the inside and outside of the acoustic cover becomes large, and the acoustic cover needs to have a pressure resistant structure. For this reason, the technique described in PTL 1 increases the manufacturing cost.

Thus, an object of the present disclosure is to provide a combustor and a gas turbine including the combustor capable of suppressing manufacturing cost.

### Solution to Problem

A combustor as one aspect according to the present disclosure for achieving the above object includes a flange that spreads in a radial direction from an axis and is attached to a gas turbine casing; an outer tube that forms a tubular shape around the axis and is disposed in the gas turbine casing and attached to the flange; an inner tube that forms a tubular shape around the axis and is disposed on an inner peripheral side of the outer tube; an in-tube injection nozzle that is disposed on an inner peripheral side of the inner tube and attached to the flange and is capable of injecting fuel; a transition piece that forms a tubular shape around the axis, is connected to the inner tube, and allows the fuel injected from the in-tube injection nozzle to be combusted on an inner peripheral side of the transition piece; and a base-end-side acoustic damper having an outer tube forming part which is a part of a plate forming the outer tube, and an acoustic cover that forms a base-end-side space in the gas turbine casing on an outer peripheral side of the outer tube in cooperation with the outer tube forming part. In a tip side that is a side where the outer tube is disposed in a case where the flange is used as a reference, and a base end side that is a side opposite to the tip side out of both sides of an axis direction in which the axis extends, the transition piece is connected to a portion of the inner tube on the tip side and extends toward the tip side. The outer tube forming part is provided with a plurality of acoustic holes penetrating the base-end-side space from the inner peripheral side of the outer tube.

The acoustic cover of the base-end-side acoustic damper can also be provided on the base end side of the flange. In this case, the base-end-side space is located outside the gas turbine casing. For this reason, a pressure difference between the inside and outside of the acoustic cover becomes large, and the acoustic cover needs to have a pressure resistant structure. Therefore, in this case, the manufacturing cost is high.

In the present aspect, since the acoustic cover of the base-end-side acoustic damper is disposed in the gas turbine casing on the outer peripheral side of the outer tube, both the pressure outside the acoustic cover and the pressure inside the acoustic cover become the pressure inside the gas turbine casing, and the acoustic cover does not need to have a pressure resistant structure. Therefore, in the present aspect, an increase in the manufacturing cost can be suppressed.

Additionally, the acoustic cover of the base-end-side acoustic damper can be provided on the outer peripheral side of the inner tube. In this case, the acoustic cover of the base-end-side acoustic damper is located in one region of the compressed air flow path between the outer tube and the inner tube. When the acoustic cover of the base-end-side acoustic damper is located in one region of the compressed air flow path, a bias occurs in the flow of compressed air in the inner tube. Specifically, for example, the flow rate of the compressed air in a region in the inner tube close to the base-end-side acoustic damper is less than the flow rate of the compressed air in a region in the inner tube far from the base-end-side acoustic damper. In this way, when a bias occurs in the flow of compressed air in the inner tube, a part of the fuel injected into the transition piece may not be completely combusted.

Thus, in the present aspect, the base-end-side acoustic damper is provided on the outer peripheral side of the outer tube to suppress the bias of the flow of the compressed air in the inner tube.

A gas turbine as one aspect according to the present disclosure for achieving the above object includes
the combustor of the above aspect; a compressor capable of compressing air to supply compressed air to the combustor; a turbine capable of being driven by combustion gas generated in the combustor; and an intermediate casing. The compressor has a compressor rotor that rotates about a rotor axis, and a compressor casing that covers an outer peripheral side of the compressor rotor. The turbine is disposed on a second side out of a first side and the second side in a rotor axis direction in which the rotor axis extends, and has a turbine rotor that rotates about the rotor axis, and a turbine casing that covers an outer peripheral side of the turbine rotor. The compressor rotor and the turbine rotor are coupled to each other to form a gas turbine rotor. The intermediate casing is disposed between the compressor casing and the turbine casing in the rotor axis direction, and forms a space into which the compressed air, which is the air compressed by the compressor, flows. The compressor casing, the intermediate casing, and the turbine casing are coupled to each other to form the gas turbine casing. The flange of the combustor is attached to the intermediate casing.

### Advantageous Effects of Invention

In one aspect of the present disclosure, it is possible to suppress the manufacturing cost of the combustor while suppressing the combustion vibration.

### BRIEF DESCRIPTION OF DRAWINGS

FIG. 1 is a schematic diagram showing a configuration of a gas turbine according to an embodiment according to the present disclosure.

FIG. 2 is a cross-sectional view of the gas turbine around a combustor according to the embodiment of the present disclosure.

FIG. 3 is a cross-sectional view of a base-end-side portion of a combustor of the gas turbine according to the embodiment according to the present disclosure.

FIG. 4 is a cross-sectional view taken along line IV-IV in FIG. 3.

FIG. 5 is a cross-sectional view taken along line V-V in FIG. 3.

FIG. 6 is a cross-sectional view taken along line VI-VI in FIGS. 4 and 5.

### DESCRIPTION OF EMBODIMENTS

Hereinafter, an embodiment of a combustor and a gas turbine including the combustor according to the present disclosure will be described in detail with reference to the drawings.

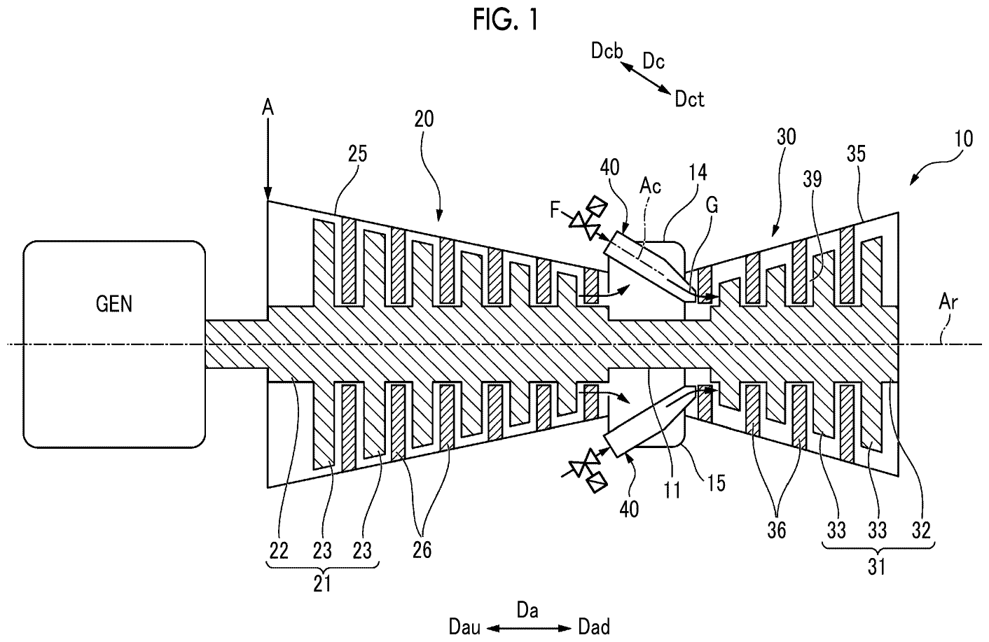

As shown in FIG. 1, the gas turbine 10 of the present embodiment has a compressor 20 that compresses outside air A to generate compressed air, and includes a plurality of combustors 40 that combust fuel F in the compressed air to generate combustion gas G, and a turbine 30 that is driven by the combustion gas G.

The compressor 20 has a compressor rotor 21 that rotates about a rotor axis Ar, a compressor casing 25 that covers the compressor rotor 21, and a plurality of stator vane rows 26. The turbine 30 has a turbine rotor 31 that rotates about the rotor axis Ar, a turbine casing 35 that covers the turbine rotor 31, and a plurality of stator vane rows 36. In addition, in the following, a direction in which the rotor axis Ar extends is referred to as a rotor axis direction Da, one side of both sides of the rotor axis direction Da is referred to as an upstream axis side Dau, and the other side is referred to as a downstream axis side Dad.

The compressor 20 is disposed on the upstream axis side Dau with respect to the turbine 30. The compressor rotor 21 and the turbine rotor 31 are located on the same rotor axis Ar and are connected to each other to form the gas turbine rotor 11. For example, a rotor of a generator GEN is connected to the gas turbine rotor 11. The gas turbine 10 further includes an intermediate casing 14 disposed between the compressor casing 25 and the turbine casing 35. The compressed air from the compressor 20 flows into the intermediate casing. The plurality of combustors 40 are attached to the intermediate casing 14 so as to be aligned in a circumferential direction with respect to the rotor axis Ar. The compressor casing 25, the intermediate casing 14, and the turbine casing 35 are connected to each other to form a gas turbine casing 15.

The compressor rotor 21 has a rotor shaft 22 extending in the rotor axis direction Da about the rotor axis Ar, and a plurality of rotor blade rows 23 attached to the rotor shaft 22. The plurality of rotor blade rows 23 are aligned in the rotor axis direction Da. All of the respective rotor blade row 23 are composed of a plurality of rotor blades aligned in the circumferential direction with respect to the rotor axis Ar. Any one stator vane row 26 of the plurality of stator vane rows 26 is disposed on the downstream axis side Dad of each of the plurality of rotor blade rows 23. Each stator vane row 26 is provided inside the compressor casing 25. All of the respective stator vane rows 26 are composed of a plurality of stator blades aligned in the circumferential direction with respect to the rotor axis Ar.

The turbine rotor 31 has a rotor shaft 32 extending in the rotor axis direction Da about the rotor axis Ar, and a plurality of rotor blade rows 33 attached to the rotor shaft 32. The plurality of rotor blade rows 33 are aligned in the rotor axis direction Da. All of the respective rotors blade row 33 are composed of a plurality of rotor blades aligned in the circumferential direction with respect to the rotor axis Ar. Any one stator vane row 36 of the plurality of stator vane rows 36 is disposed on the upstream axis side Dau of each of the plurality of rotor blade rows 33. Each stator vane row 36 is provided inside the turbine casing 35. All of the respective stator vane rows 36 are composed of a plurality of stator blades aligned in the circumferential direction with respect to the rotor axis Ar. A region where the plurality of stator vane rows 36 and the plurality of rotor blade rows 33 are disposed is formed in an annular space between an inner peripheral side of the turbine casing 35 and an outer peripheral side of the rotor shaft 32 to form a combustion gas flow path 39 through which the combustion gas G from the combustor 40 flows.

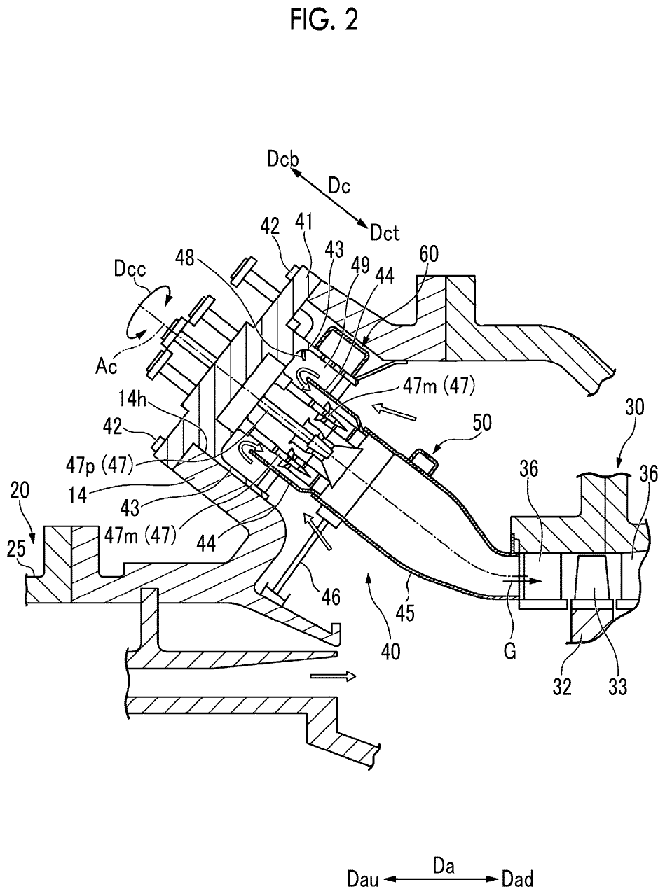

As shown in FIG. 2, the combustor 40 includes a flange 41, an outer tube 43, an inner tube 44, a transition piece 45, a plurality of in-tube injection nozzles 47, a flow path injection nozzle 48, and a base-end-side acoustic damper 60, and a tip-side acoustic damper 50.

The flange 41 spreads in a radial direction from a combustor axis Ac. All of the outer tube 43, the inner tube 44, and the transition piece 45 are disposed in the intermediate casing 14. Additionally, all of the outer tube 43, the inner tube 44, and the transition piece 45 have a tubular shape around the combustor axis Ac. Here, for the convenience of the following description, a direction in which the combustor axis Ac extends is referred to as the axis direction Dc. Additionally, the circumferential direction with respect to the combustor axis Ac is simply referred to as a circumferential direction Dcc. Additionally, one side of both sides of the axis direction Dc is referred to as a tip side Dct and the other side thereof is referred to as a base end side Dcb. In addition, as shown in FIG. 1, the tip side Dct is the downstream axis side Dad in the rotor axis direction Da, and the base end side Dcb is the upstream axis side Dau in the rotor axis direction Da. Additionally, the combustor axis Ac is inclined with respect to the rotor axis Ar so as to approach the rotor axis Ar toward the tip side Dct.

The intermediate casing 14 is provided with a combustor attachment hole 14h penetrating into the intermediate casing 14 from the outside of the intermediate casing 14. The flange 41 is attached to the intermediate casing 14 with bolts 42 so as to block the combustor attachment hole 14h. The outer tube 43 is disposed in the intermediate casing 14 and is attached to the tip side Dct of the flange 41. A portion composed of the flange 41 and the outer tube 43 may be referred to as a top hat because of the shape thereof. The inner tube 44 is disposed on the inner peripheral side of the outer tube 43 and is attached to the outer tube 43 or the flange 41 via a support or the like. The plurality of in-tube injection nozzles 47 are disposed on an inner peripheral side of the inner tube 44. The transition piece 45 is connected to the tip of the inner tube 44 via a seal member or the like. The transition piece 45 is supported by a transition piece support 46 fixed to an inner surface of the intermediate casing 14.

All of the plurality of in-tube injection nozzles 47 extend in the axis direction Dc and are provided with a hole for injecting fuel. All of the plurality of in-tube injection nozzles 47 are fixed to the flange 41. The portion of the flange 41 to which the plurality of in-tube injection nozzles 47 are fixed may be referred to as a nozzle base. One nozzle of the plurality of in-tube injection nozzles 47 is a pilot nozzle 47p, and the other plurality of nozzles are main nozzles 47m. The pilot nozzle 47p is disposed on the combustor axis Ac. The plurality of main nozzles 47m are aligned in the circumferential direction Dcc around the pilot nozzle 47p.

An annular space between an inner peripheral side of the outer tube 43 and an outer peripheral side of the inner tube 44 forms a compressed air flow path 49 through which the compressed air from the inside of the intermediate casing 14 flows. The flow path injection nozzle 48 is disposed in the compressed air flow path 49 and attached to the flange 41. The flow path injection nozzle 48 may be referred to as a top hat nozzle because of the relationship in which the flow path injection nozzle 48 is attached to the aforementioned top hat. The flow path injection nozzle 48 injects fuel into the compressed air flow path 49. A gap is present between the flange 41 and the inner tube 44 in the axis direction Dc. The compressed air in the compressed air flow path 49 flows into the inner tube 44 from the gap. The compressed air that has flowed into the inner tube 44 flows out into the transition piece 45. Fuel is injected into the transition piece 45 from the plurality of in-tube injection nozzles 47. This fuel is combusted in the transition piece 45. The combustion gas G generated by this combustion is guided into the combustion gas flow path 39 of the turbine 30 by the transition piece 45.

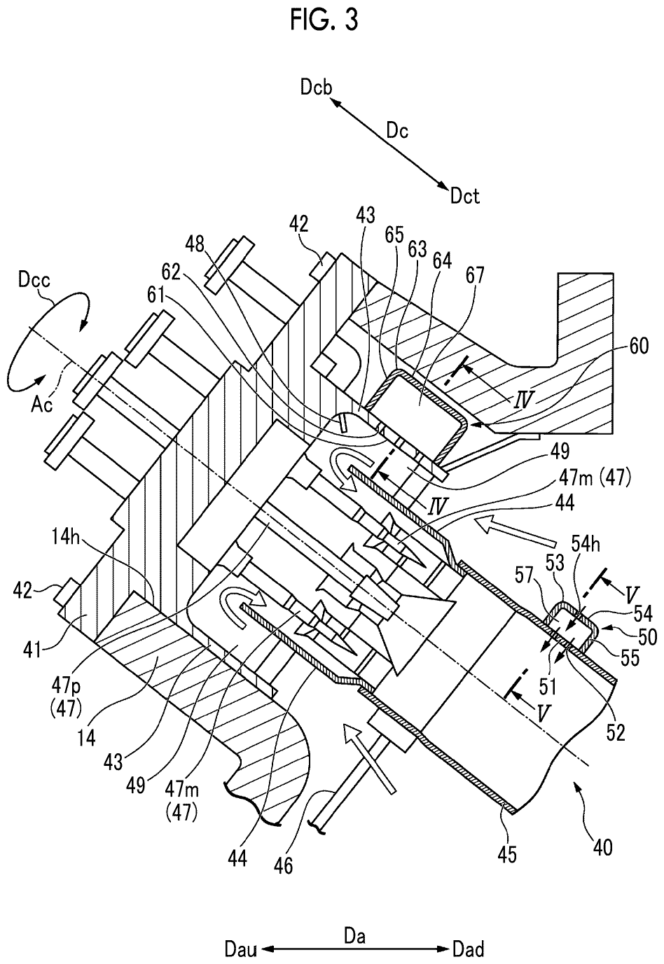

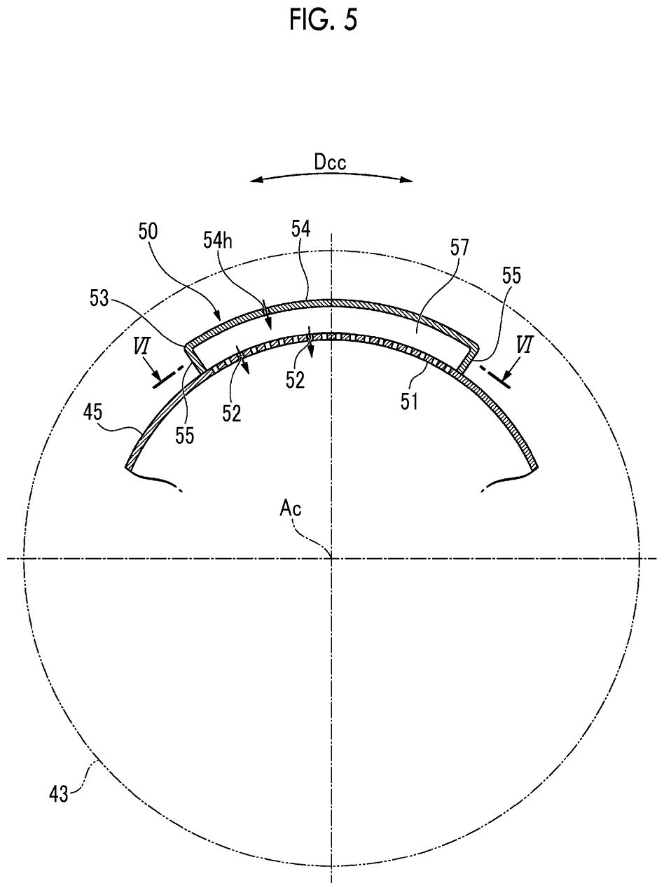

As shown in FIGS. 3 and 5, the tip-side acoustic damper 50 has a transition piece forming part 51 which is a part of a plate forming the transition piece 45, and has an acoustic cover 53 that forms a tip-side acoustic space (hereinafter referred to as a tip-side space) 57 on an outer peripheral side of the transition piece 45 in cooperation with the transition piece forming part 51. The acoustic cover 53 extends in the circumferential direction Dcc. Thus, a tip-side space 57 in the acoustic cover 53 also extends in the circumferential direction Dcc. The acoustic cover 53 has a top plate 54 facing an outer peripheral surface of the transition piece forming part 51, and a side plate 55 connecting the top plate 54 and an outer peripheral surface of the transition piece 45 to each other. The transition piece forming part 51 is provided with a plurality of acoustic holes 52 penetrating into the tip-side space 57 from the inner peripheral side of the transition piece 45. Additionally, the top plate 54 of the acoustic cover 53 is provided with an air intake 54h that guides the compressed air in the intermediate casing 14 into the tip-side space 57.

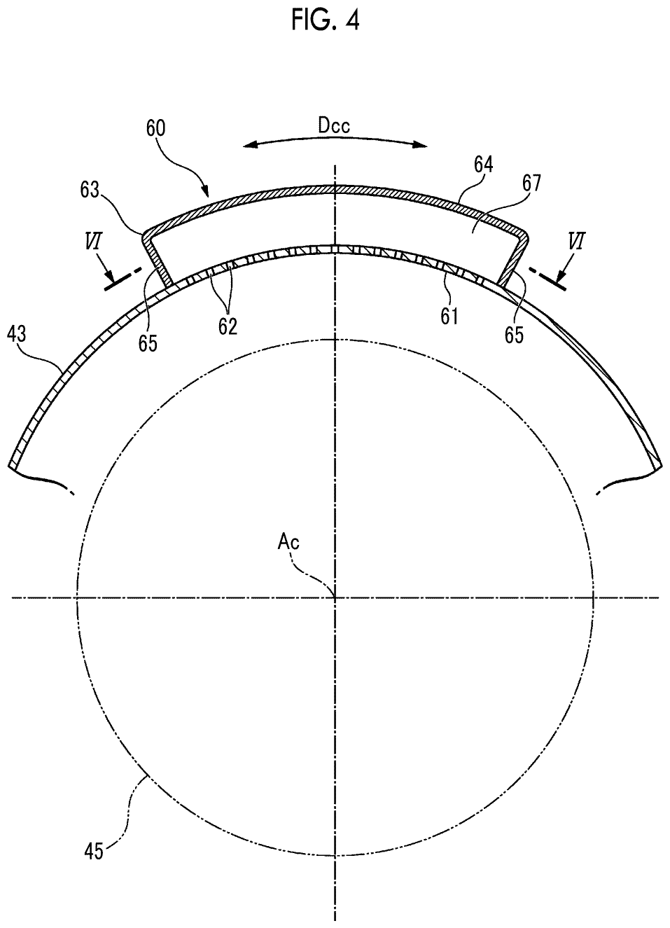

As shown in FIGS. 3 and 4, the base-end-side acoustic damper 60 has an outer tube forming part 61 which is a part of a plate forming the outer tube 43, and has an acoustic cover 63 that forms a base-end-side acoustic space (hereinafter referred to as a base-end-side space) 67 on an outer peripheral side of the outer tube 43 in cooperation with the outer tube forming part 61. The acoustic cover 63 extends in the circumferential direction Dcc. Thus, the base-end-side space 67 in the acoustic cover 63 also extends in the circumferential direction Dcc. The acoustic cover 63 has a top plate 64 facing an outer peripheral surface of the outer tube forming part 61, and a side plate 65 connecting the top plate 64 and an outer peripheral surface of the outer tube 43 to each other. The outer tube forming part 61 is provided with a plurality of acoustic holes 62 penetrating into the base-end-side space 67 from the inner peripheral side of the outer tube 43.

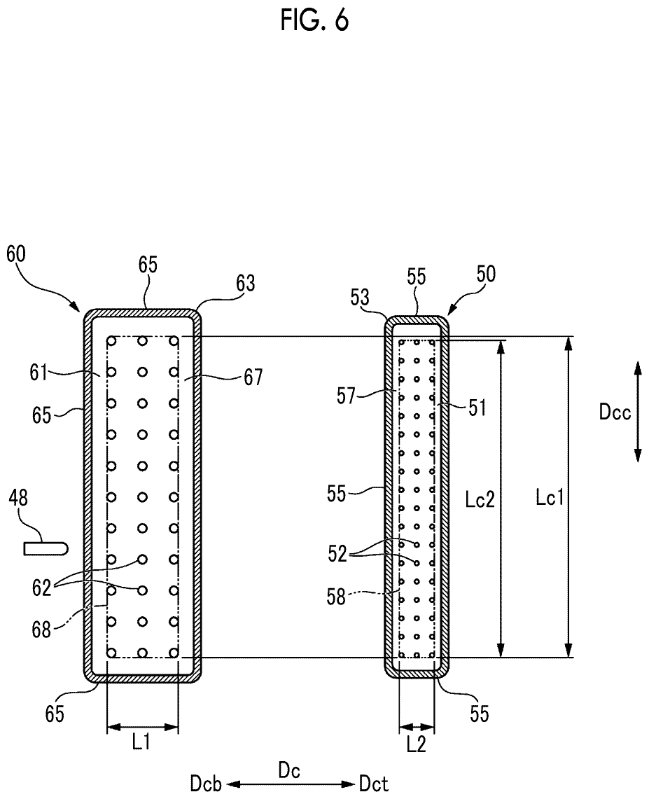

Here, as shown in FIG. 6, a region of the transition piece forming part 51 where the plurality of acoustic holes 52 are formed is referred to as a tip-side hole forming region 58, and a region of the outer tube forming part 61 where the plurality of acoustic holes 62 are formed is referred to as a base-end-side hole forming region 68. The plurality of acoustic holes 52 constitute a hole group. Additionally, the plurality of acoustic holes 62 also constitute a hole group. All of the above hole forming regions are regions surrounded by a line circumscribing the plurality of outermost acoustic holes among the plurality of acoustic holes in the hole group. A width L1 of the base-end-side hole forming region 68 in the axis direction Dc is larger than a width L2 of the tip-side hole forming region 58 in the axis direction Dc. Additionally, a width Lc1 of the base-end-side hole forming region 68 of the circumferential direction Dcc is larger than a width Lc2 of the tip-side hole forming region 58 in the circumferential direction Dcc. For this reason, the area of the base-end-side hole forming region 68 is larger than the area of the tip-side hole forming region 58.

Additionally, the base-end-side hole forming region 68 is disposed closer to the tip side Dct than a position where the flow path injection nozzle 48 injects fuel.

As described above, since the combustor 40 of the present embodiment includes the tip-side acoustic damper 50 and the base-end-side acoustic damper 60, combustion vibration can be suppressed.

The base-end-side acoustic damper 60 is farther from a generation source of the combustion vibration than the tip-side acoustic damper 50. In addition, the position of the combustion vibration generation source is in the transition piece 45. For this reason, in the present embodiment, the area of the base-end-side hole forming region 68 is made larger than the area of the tip-side hole forming region 58 in order to enhance the effect of suppressing the combustion vibration by the base-end-side acoustic damper 60. In the present embodiment, as described above, the width L1 of the base-end-side hole forming region 68 in the axis direction Dc is larger than the width L2 of the tip-side hole forming region 58 in the axis direction Dc, and the width Lc1 of the base-end-side hole forming region 68 in the circumferential direction Dcc is larger than the width Lc2 of the tip-side hole forming region 58 in the circumferential direction Dcc. However, if the area of the base-end-side hole forming region 68 is larger than the area of the tip-side hole forming region 58, it is not necessary that the width L1 of the base-end-side hole forming region 68 in the axis direction Dc is larger than the width L2 of the tip-side hole forming region 58 in the axis direction Dc, and the width Lc1 of the base-end-side hole forming region 68 in the circumferential direction Dcc is larger than the width Lc2 of the tip-side hole forming region 58 in the circumferential direction Dcc.

Meanwhile, it is not necessary for the tip-side acoustic damper 50 to have the air intake 54h for suppressing the combustion vibration. However, in a case where the tip-side acoustic damper 50 does not have the air intake 54h, there is a concern that high-temperature gas such as combustion gas generated in the transition piece 45 may flow into the tip-side space 57 through the acoustic holes 52. For this reason, in this case, it is necessary to apply heat resistance treatment to a surface defining the tip-side space 57 by the tip-side acoustic damper 50. Thus, in the present embodiment, the air intake 54h is formed in the acoustic cover 53 of the tip-side acoustic damper 50. The compressed air in the intermediate casing 14 flows into the tip-side space 57 from the air intake 54h. The compressed air that has flowed into the tip-side space 57 flows out into the transition piece 45 from the acoustic holes 52. In this way, the compressed air flowing out into the transition piece 45 from the acoustic holes 52 can prevent the high-temperature gas generated in the transition piece 45 from flowing into the tip-side space 57 through the acoustic holes 52.

The air flowing out into the transition piece 45 from the inside of the tip-side acoustic damper 50 cools an inner peripheral surface of the transition piece 45, and cools a flammable gas jetted from the in-tube injection nozzles 47 into the transition piece 45, for example, fuel gas or premixed gas in which fuel and air are premixed. When the flammable gas is cooled, the fuel contained in the flammable gas is not completely combusted and CO is generated. In general, combustors are required to reduce the emissions of CO generated due to incomplete combustion of fuel from the viewpoint of environmental protection.

The combustor 40 of the present embodiment includes a base-end-side acoustic damper 60 in addition to the tip-side acoustic damper 50. For this reason, it is possible to obtain a desired acoustic damping effect even if the total opening area of all the acoustic holes 52 formed in the tip-side hole forming region 58 is smaller than in the case of only the tip-side acoustic damper 50. Thus, in the present embodiment, the flow rate of air flowing out into the transition piece 45 from the inside of the tip-side acoustic damper 50 can be suppressed as compared to a case of only the tip-side acoustic damper 50 while obtaining a desired acoustic damping effect, and the emissions of CO can be reduced.

The acoustic cover of the base-end-side acoustic damper 60 can also be provided on the base end side Dcb of the flange 41. In this case, the base-end-side space is located outside the gas turbine casing 15. For this reason, a pressure difference between the inside and outside of the acoustic cover becomes large, and the acoustic cover needs to have a pressure resistant structure. Therefore, in this case, the manufacturing cost is high.

In the present embodiment, since the acoustic cover 63 of the base-end-side acoustic damper 60 is disposed in the gas turbine casing 15 on the outer peripheral side of the outer tube 43, both the pressure outside the acoustic cover 63 and the pressure inside the acoustic cover 63 become the pressure inside the gas turbine casing 15, and the acoustic cover 63 does not need to have the pressure resistant structure. Therefore, in the present embodiment, an increase in the manufacturing cost can be suppressed.

Additionally, the acoustic cover of the base-end-side acoustic damper 60 can be provided on the outer peripheral side of the inner tube 44. In this case, the acoustic cover of the base-end-side acoustic damper 60 is located in one region of the compressed air flow path 49. When the acoustic cover of the base-end-side acoustic damper 60 is located in one region of the compressed air flow path 49, a bias occurs in the flow of compressed air in the inner tube 44. Specifically, for example, the flow rate of the compressed air in a region in the inner tube 44 close to the base-end-side acoustic damper 60 is less than the flow rate of the compressed air in a region in the inner tube 44 far from the base-end-side acoustic damper 60. In this way, when a bias occurs in the flow of compressed air in the inner tube 44, a part of the fuel injected into the transition piece 45 may not be completely combusted.

Thus, in the present embodiment, the base-end-side acoustic damper 60 is provided on the outer peripheral side of the outer tube 43 to suppress the bias of the flow of the compressed air in the inner tube 44.

In the present embodiment, as described above, the base-end-side hole forming region 68 is disposed at the closer to the tip side Dct of the fuel injection position of the flow path injection nozzle 48. Here, temporarily, an air intake is provided in the acoustic cover 63 of the base-end-side acoustic damper 60 so that compressed air flows out into the compressed air flow path 49 through the acoustic hole 62 from the inside of the base-end-side space 67. In this case, in the present embodiment, the bias of the fuel concentration in the compressed air in the inner tube 44 is suppressed as compared to a case where the base-end-side hole forming region 68 is disposed closer to the base end side Dcb than the fuel injection position.

In addition, the combustor 40 of the present embodiment includes the tip-side acoustic damper 50 and the base-end-side acoustic damper 60. However, if the desired acoustic damping effect can be obtained only with the base-end-side acoustic damper 60, the tip-side acoustic damper 50 may be omitted.

### [Additional Notes]

The combustor in the above embodiment is grasped as follows, for example.

(1) A combustor in a first aspect includes
a flange 41 that spreads in a radial direction from an axis Ac and is attached to a gas turbine casing 15; an outer tube 43 that forms a tubular shape around the axis Ac and is disposed in the gas turbine casing 15 and attached to the flange 41; an inner tube 44 that forms a tubular shape around the axis Ac and is disposed on an inner peripheral side of the outer tube 43; an in-tube injection nozzle 47 that is disposed on an inner peripheral side of the inner tube 44 and attached to the flange 41 and is capable of injecting fuel; a transition piece 45 that forms a tubular shape around the axis Ac, is connected to the inner tube 44, and allows the fuel injected from the in-tube injection nozzle 47 to be combusted on an inner peripheral side of the transition piece; and a base-end-side acoustic damper 60 having an outer tube forming part 61 which is a part of a plate forming the outer tube 43, and an acoustic cover 63 that forms a base-end-side space 67 in the gas turbine casing 15 on an outer peripheral side of the outer tube 43 in cooperation with the outer tube forming part 61. In a tip side Dct that is a side where the outer tube 43 is disposed in a case where the flange 41 is used as a reference, and a base end side Dcb that is a side opposite to the tip side Dct out of both sides of an axis direction Dc in which the axis Ac extends, the transition piece 45 is connected to a portion of the inner tube 44 on the tip side Dct and extends toward the tip side Dct. The outer tube forming part 61 is provided with a plurality of acoustic holes 62 penetrating the base-end-side space 67 from the inner peripheral side of the outer tube 43.

The acoustic cover of the base-end-side acoustic damper 60 can also be provided on the base end side Dcb of the flange 41. In this case, the base-end-side space is located outside the gas turbine casing 15. For this reason, a pressure difference between the inside and outside of the acoustic cover becomes large, and the acoustic cover needs to have a pressure resistant structure. Therefore, in this case, the manufacturing cost is high.

In the present aspect, since the acoustic cover 63 of the base-end-side acoustic damper 60 is disposed in the gas turbine casing 15 on the outer peripheral side of the outer tube 43, both the pressure outside the acoustic cover 63 and the pressure inside the acoustic cover 63 become the pressure inside the gas turbine casing 15, and the acoustic cover 63 does not need to have a pressure resistant structure. Therefore, in the present aspect, an increase in the manufacturing cost can be suppressed.

Additionally, the acoustic cover of the base-end-side acoustic damper 60 can be provided on the outer peripheral side of the inner tube 44. In this case, the acoustic cover of the base-end-side acoustic damper 60 is located in one region of the compressed air flow path 49 between the outer tube 43 and the inner tube 44. When the acoustic cover of the base-end-side acoustic damper 60 is located in one region of the compressed air flow path 49, a bias occurs in the flow of compressed air in the inner tube 44. Specifically, for example, the flow rate of the compressed air in a region in the inner tube 44 close to the base-end-side acoustic damper 60 is less than the flow rate of the compressed air in a region in the inner tube 44 far from the base-end-side acoustic damper 60. In this way, when a bias occurs in the flow of compressed air in the inner tube 44, a part of the fuel injected into the transition piece 45 may not be completely combusted.

Thus, in the present aspect, the base-end-side acoustic damper 60 is provided on the outer peripheral side of the outer tube 43 to suppress the bias of the flow of the compressed air in the inner tube 44.

(2) The combustor in a second aspect is
the combustor of the first aspect further including a tip-side acoustic damper 50 having a transition piece forming part 51 which is a part of a plate forming the transition piece 45, and an acoustic cover 53 forming a tip-side space 57 on an outer peripheral side of the transition piece 45 in cooperation with the transition piece forming part 51. The transition piece forming part 51 is provided with a plurality of acoustic holes 52 penetrating into the tip-side space 57 from the inner peripheral side of the transition piece 45.

In the present aspect, the combustion vibration can be suppressed as compared to a case where only the base-end-side acoustic damper 60 out of the base-end-side acoustic damper 60 and the tip-side acoustic damper 50 is used.

(3) The combustor in a third aspect is
the combustor of the second aspect in which an area of a hole forming region 68 of the outer tube forming part 61 in which the plurality of acoustic holes 62 are formed is larger than an area of a hole forming region 58 of the transition piece forming part 51 in which the plurality of acoustic holes 52 are formed.

The base-end-side acoustic damper 60 is farther from a generation source of the combustion vibration than the tip-side acoustic damper 50. For this reason, in the present aspect, the area of the base-end-side hole forming region 68 is made larger than the area of the tip-side hole forming region 58 in order to enhance the effect of suppressing the combustion vibration by the base-end-side acoustic damper 60.

(4) The combustor in the fourth aspect is
the combustor of any one of the first to the third aspects further including a flow path injection nozzle 48 that injects the fuel into an annular compressed air flow path 49 between the inner peripheral side of the outer tube 43 and an outer peripheral side of the inner tube 44. The flow path injection nozzle 48 is attached to the flange 41. A hole forming region 68 of the outer tube forming part 61 in which the plurality of acoustic holes 62 are formed is disposed closer to the tip side Dct than a position where the flow path injection nozzle 48 injects the fuel.

Temporarily, an air intake is provided in the acoustic cover 63 of the base-end-side acoustic damper 60 so that compressed air flows out into the compressed air flow path 49 through the acoustic hole 62 from the inside of the base-end-side space 67. In this case, in the present aspect, the bias of the fuel concentration in the compressed air in the inner tube 44 is suppressed as compared to a case where the base-end-side hole forming region 68 is disposed closer to the base end side Dcb than the fuel injection position of the flow path injection nozzle 48.

The gas turbine in the above embodiment is grasped as follows, for example.

(5) A gas turbine in a fifth aspect includes
the combustor 40 of any one of the first to the fourth aspects; a compressor 20 capable of compressing air to supply compressed air to the combustor 40; a turbine 30 capable of being driven by combustion gas generated in the combustor 40; and an intermediate casing 14. The compressor 20 has a compressor rotor 21 that rotates about a rotor axis Ar, and a compressor casing 25 that covers an outer peripheral side of the compressor rotor 21. The turbine 30 is disposed on a second side out of a first side and the second side in a rotor axis direction Da in which the rotor axis Ar extends, and has a turbine rotor 31 that rotates about the rotor axis Ar, and a turbine casing 35 that covers an outer peripheral side of the turbine rotor 31. The compressor rotor 21 and the turbine rotor 31 are coupled to each other to form a gas turbine rotor 11. The intermediate casing 14 is disposed between the compressor casing 25 and the turbine casing 35 in the rotor axis direction Da, and forms a space into which the compressed air, which is the air compressed by the compressor 20, flows. The compressor casing 25, the intermediate casing 14, and the turbine casing 35 are coupled to each other to form the gas turbine casing 15.

The flange 41 of the combustor 40 is attached to the intermediate casing 14.

### INDUSTRIAL APPLICABILITY

In one aspect of the present disclosure, it is possible to suppress the manufacturing cost of the combustor while suppressing the combustion vibration.

### REFERENCE SIGNS LIST

10: Gas turbine
11: Gas turbine rotor
14: Intermediate casing
14h: Combustor attachment hole
15: Gas turbine casing
20: Compressor
21: Compressor rotor
22: Rotor shaft
23: Rotor blade row
25: Compressor casing
26: Stator vane row
30: Turbine
31: Turbine rotor
32: Rotor shaft
33: Rotor blade row
35: Turbine casing
36: Stator vane row
39: Combustion gas flow path
40: Combustor
41: Flange
42: Bolt
43: Outer tube
44: Inner tube
45: Transition piece
46: Transition piece support
47: In-tube injection nozzle
47p: Pilot nozzle
47m: Main nozzle
48: Flow path injection nozzle
49: Compressed air flow path
50: Tip-side acoustic damper
51: Transition piece forming part
52: Acoustic hole
53: Acoustic cover
54: top plate
54h: Air intake
55: Side plate
56: Partition plate
57: Tip-side acoustic space (or tip-side space)
58: Tip-side hole forming region
60: Base-end-side acoustic damper
61: Outer tube forming part
62: Acoustic hole
63: Acoustic cover
64: Top plate
65: Side plate
66: Partition plate
67: Base-end-side acoustic space (or base-end-side space)
68: Base-end-side hole forming region
A: Outside air
F: Fuel
G: Combustion gas
Ar: Rotor axis
Ac: Combustor axis
Da: Rotor axis direction
Dau: Upstream axis side
Dad: Downstream axis side
Dc: Axis direction
Dcb: Base end side
Dct: Tip side
Dcc: Circumferential direction

What is claimed is:

1. A combustor comprising:
an inner tube that forms a tubular shape and has an in-tube injection nozzle disposed on an inner peripheral side of the inner tube, the in-tube injection nozzle being capable of injecting fuel;
an outer tube that forms a tubular shape and is disposed on a radial outer side with respect to a central axis of the inner tube and spaced apart from an outer peripheral wall surface of the inner tube; and
a base-end-side acoustic damper disposed within a gas turbine casing and provided on an outer peripheral wall surface of the outer tube,
wherein an annular air flow path through which air flows is formed between an inner peripheral wall surface of the outer tube and only a portion of the outer peripheral wall surface of the inner tube which is upstream of a tip of the in-tube injection nozzle when viewed in the flow direction of air flowing inside the inner tube, and such that the air is guided to an end portion of the inner tube located on an upstream side of the inner tube so that air flows into the inside of the inner tube, and the air flowing through the annular air flow path does not contain combustion gas generated by combustion of fuel injected from the in-tube injection nozzle,
wherein the base-end-side acoustic damper has a base-end-side space formed by a first area on the outer peripheral wall surface of the outer tube and an acoustic cover provided on the outer peripheral wall surface, and a plurality of first acoustic holes extending from the outer peripheral wall surface of the outer tube to the inner peripheral wall surface of the outer tube so as to communicate the annular air flow path with the base-end-side space,
wherein openings of the plurality of first acoustic holes on a side of the inner peripheral wall surface are present within the first area.

2. The combustor according to claim 1, wherein an entirety of the base-end-side space is present only on a radial outer side with respect to the annular air flow path.

3. The combustor according to claim 1, further comprising:
a transition piece that forms a tubular shape, is connected to the inner tube, and allows the fuel injected from the in-tube injection nozzle to be combusted on an inner peripheral side of the transition piece; and
a tip-side acoustic damper having a transition piece forming part which is a part of a wall forming the transition piece, and an acoustic cover forming a tip-side space on an outer peripheral side of the transition piece in cooperation with the transition piece forming part,
wherein the transition piece forming part is provided with a plurality of second acoustic holes penetrating into the tip-side space from the inner peripheral side of the transition piece.

4. The combustor according to claim 3, wherein an area of a hole forming region of the inner peripheral wall surface of the outer tube in which the plurality of first acoustic holes are formed is larger than an area of a hole forming region of an inner peripheral wall surface of the transition piece in which the plurality of second acoustic holes are formed.

5. The combustor according to claim 1, further comprising a flow path injection nozzle configured to inject fuel into the air flowing from the end portion of the inner tube located on the upstream side of the inner tube into the inner tube.

6. The combustor according to claim 5, wherein the flow path injection nozzle is disposed downstream of the base-end-side acoustic damper with respect to a flow direction of the air flowing inside the annular air flow path.

7. The combustor according to claim 5, wherein the flow path injection nozzle is disposed downstream of the end portion of the inner tube with respect to a flow direction of the air flowing inside the annular air flow path.

8. A gas turbine comprising:
the combustor according to claim 1;
a compressor that compresses air and supplies compressed air to the combustor;
a turbine driven by combustion gas generated in the combustor; and
an intermediate casing,
wherein the compressor has a compressor rotor that rotates about a rotor axis, and a compressor casing that covers an outer peripheral side of the compressor rotor,
wherein the turbine is disposed on a second side, among a first side and the second side, in a rotor axis direction in which the rotor axis extends, and has a turbine rotor that rotates about the rotor axis, and a turbine casing that covers an outer peripheral side of the turbine rotor,
wherein the compressor rotor and the turbine rotor are connected to each other to form a gas turbine rotor,
wherein the intermediate casing is disposed between the compressor casing and the turbine casing in the rotor axis direction, and forms a space into which compressed air that is air compressed by the compressor flows,
wherein the compressor casing, the intermediate casing, and the turbine casing are connected to each other to form the gas turbine casing, and
the combustor is attached to the intermediate casing.

9. A combustor comprising:
an inner tube that forms a tubular shape and has an in-tube injection nozzle disposed on an inner peripheral side of the inner tube, the in-tube injection nozzle being capable of injecting fuel;
an outer tube that forms a tubular shape and is disposed on a radial outer side with respect to a central axis of the inner tube and spaced apart from an outer peripheral wall surface of the inner tube; and
a base-end-side acoustic damper disposed within a gas turbine casing and provided on an outer peripheral wall surface of the outer tube,
wherein an annular air flow path through which air flows is formed between an inner peripheral wall surface of the outer tube and the outer peripheral wall surface of the inner tube, such that the air is guided to an air inflow side end portion of the inner tube so that air flows into the inside of the inner tube, and the air flowing through the annular air flow path does not contain combustion gas generated by combustion of fuel injected from the in-tube injection nozzle,
wherein the base-end-side acoustic damper has a base-end-side space formed by a first area on the outer peripheral wall surface of the outer tube and an acoustic cover provided on the outer peripheral wall surface, and a plurality of first acoustic holes extending from the outer peripheral wall surface of the outer tube to the inner peripheral wall surface of the outer tube so as to communicate the annular air flow path with the base-end-side space,
wherein the base-end-side acoustic damper is disposed on an upstream side of a position where the fuel injected from the in-tube injection nozzle combusts when viewed in the flow direction of air flowing inside the inner tube, and
wherein openings of the plurality of first acoustic holes on a side of the inner peripheral wall surface are present within the first area.

10. The combustor according to claim 9, wherein an entirety of the base-end-side space is present only on a radial outer side with respect to the annular air flow path.

11. The combustor according to claim 9, further comprising:
a transition piece that forms a tubular shape, is connected to the inner tube, and allows the fuel injected from the in-tube injection nozzle to be combusted on an inner peripheral side of the transition piece; and
a tip-side acoustic damper having a transition piece forming part which is a part of a wall forming the transition piece, and an acoustic cover forming a tip-side space on an outer peripheral side of the transition piece in cooperation with the transition piece forming part,
wherein the transition piece forming part is provided with a plurality of second acoustic holes penetrating into the tip-side space from the inner peripheral side of the transition piece.

12. The combustor according to claim 11, wherein an area of a hole forming region of the inner peripheral wall surface of the outer tube in which the plurality of first acoustic holes are formed is larger than an area of a hole forming region of an inner peripheral wall surface of the transition piece in which the plurality of second acoustic holes are formed.

13. The combustor according to claim 9, further comprising a flow path injection nozzle configured to inject fuel into the air flowing from the air inflow side end portion of the inner tube into the inner tube.

14. The combustor according to claim 13, wherein the flow path injection nozzle is disposed downstream of the base-end-side acoustic damper with respect to a flow direction of the air flowing inside the annular air flow path.

15. The combustor according to claim 13, wherein the flow path injection nozzle is disposed downstream of the air inflow side end portion of the inner tube with respect to a flow direction of the air flowing inside the annular air flow path.

16. A gas turbine comprising:
the combustor according to claim 9;
a compressor that compresses air and supplies compressed air to the combustor;
a turbine driven by combustion gas generated in the combustor; and
an intermediate casing,
wherein the compressor has a compressor rotor that rotates about a rotor axis, and a compressor casing that covers an outer peripheral side of the compressor rotor,
wherein the turbine is disposed on a second side, among a first side and the second side, in a rotor axis direction in which the rotor axis extends, and has a turbine rotor that rotates about the rotor axis, and a turbine casing that covers an outer peripheral side of the turbine rotor,
wherein the compressor rotor and the turbine rotor are connected to each other to form a gas turbine rotor,
wherein the intermediate casing is disposed between the compressor casing and the turbine casing in the rotor axis direction, and forms a space into which compressed air that is air compressed by the compressor flows,
wherein the compressor casing, the intermediate casing, and the turbine casing are connected to each other to form the gas turbine casing, and
wherein the combustor is attached to the intermediate casing.

17. A combustor comprising:
an inner tube that forms a tubular shape and has an in-tube injection nozzle disposed on an inner peripheral side of the inner tube, the in-tube injection nozzle being capable of injecting fuel;
an outer tube that forms a tubular shape and is disposed on a radial outer side with respect to a central axis of the inner tube and spaced apart from an outer peripheral wall surface of the inner tube; and
a base-end-side acoustic damper disposed within a gas turbine casing and provided on an outer peripheral wall surface of the outer tube,
wherein an annular air flow path through which air flows is formed between an inner peripheral wall surface of the outer tube and the outer peripheral wall surface of the inner tube, an air inlet of the annular air flow path being upstream of a tip of the in-tube injection nozzle when viewed in the flow direction of air flowing inside the inner tube, the annular air flow path being formed such that the air is guided to an end portion of the inner tube located on an upstream side of the inner tube so that air flows into the inside of the inner tube, and the air flowing through the annular air flow path does not contain combustion gas generated by combustion of fuel injected from the in-tube injection nozzle,
wherein the base-end-side acoustic damper has a base-end-side space formed by a first area on the outer peripheral wall surface of the outer tube and an acoustic cover provided on the outer peripheral wall surface, and a plurality of first acoustic holes extending from the outer peripheral wall surface of the outer tube to the inner peripheral wall surface of the outer tube so as to communicate the annular air flow path with the base-end-side space,
wherein openings of the plurality of first acoustic holes on a side of the inner peripheral wall surface are present within the first area.

18. The combustor according to claim 17, further comprising:
a transition piece that forms a tubular shape, is connected to the inner tube, and allows the fuel injected from the in-tube injection nozzle to be combusted on an inner peripheral side of the transition piece; and
a tip-side acoustic damper having a transition piece forming part which is a part of a wall forming the transition piece, and an acoustic cover forming a tip-side space on an outer peripheral side of the transition piece in cooperation with the transition piece forming part,
wherein the transition piece forming part is provided with a plurality of second acoustic holes penetrating into the tip-side space from the inner peripheral side of the transition piece.

19. The combustor according to claim 18, wherein an area of a hole forming region of the inner peripheral wall surface of the outer tube in which the plurality of first acoustic holes are formed is larger than an area of a hole forming region of an inner peripheral wall surface of the transition piece in which the plurality of second acoustic holes are formed.

20. The combustor according to claim 17, further comprising a flow path injection nozzle configured to inject fuel into the air flowing from the end portion of the inner tube located on the upstream side of the inner tube into the inner tube, wherein the flow path injection nozzle is disposed downstream of the base-end-side acoustic damper with respect to a flow direction of the air flowing inside the annular air flow path.
